(19) United States
(12) Patent Application Publication
(10) Pub. No.: US 2025/0278154 A1
(43) Pub. Date: Sep. 4, 2025

(54) TOUCH CONTROLLER WITH INTEGRATED RFID READ CAPABILITIES, INCLUDING RELATED SYSTEMS, APPARATUSES, AND METHODS

(71) Applicant: Microchip Touch Solutions Limited, Wokingham (GB)

(72) Inventors: Lee Tarrant, Southampton (GB); Lucas Shepherd, Southampton (GB)

(21) Appl. No.: 19/064,904

(22) Filed: Feb. 27, 2025

Related U.S. Application Data
(60) Provisional application No. 63/559,745, filed on Feb. 29, 2024.

(51) Int. Cl. G06F 3/044; G06F 3/041; G06F 21/60; G06K 7/10

(52) U.S. Cl. CPC G06F 3/044; G06F 3/04164; G06F 21/602; G06K 7/10297

(57) ABSTRACT

An apparatus comprises a capacitive touch system. The capacitive touch system includes a touch controller, a touch sensor operably coupled to the touch controller, and a radio frequency (RF) identification (RFID) antenna operably coupled to the touch controller. The touch controller is to receive capacitance signals from the touch sensor; determine touch position data based, at least in part, on the capacitance signals; drive an RF signal to the RFID antenna for transmission of the RF signal from the RFID antenna, the RF signal to activate an RFID tag to produce a modulated RF signal modulated according to RFID data of the RFID tag; receive a demodulated signal indicating the RFID data, the demodulated signal demodulated from the modulated RF signal received from the RFID antenna; and detect the RFID data from the demodulated signal.

### CROSS-REFERENCE TO RELATED APPLICATION

This application claims the benefit under 35 U.S.C. § 119(e) of U.S. Provisional Patent Application Ser. No. 63/559,745, filed Feb. 29, 2024, the disclosure of which is hereby incorporated herein in its entirety by this reference.

### TECHNICAL FIELD

Examples relate, generally, to capacitive touch systems. More particularly, some examples relate to touch controllers for touchscreens of capacitive touch systems, with the touch controller including integrated radio frequency identification (RFID) read capabilities. Additionally, systems, apparatuses, and methods are disclosed.

### BACKGROUND

Point of Sale (PoS) systems include PoS devices used to process transactions for customers. Some PoS systems are in the form of electronic PoS systems configured to process electronic transactions involving credit or debit cards. The electronic PoS systems may include touchscreens of capacitive touch systems to facilitate user interactions associated with the transactions. The credit or debit cards typically convey information associated with a cardholder's account, using either a magnetic strip along one side of the card or a radio frequency (RF) identification (RFID) chip embedded within the card. When a credit card having an RFID chip is brought near an RFID-enabled PoS system, the RFID chip is activated to communicate with the system to convey information associated with the cardholder's account.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 depicts a Point of Sale (PoS) system including a PoS device for processing PoS transactions;

FIG. 2 depicts an apparatus including a capacitive touch system that is known by the inventors of this disclosure;

FIG. 3 is a schematic block diagram of a touch controller in a conventional circuit arrangement;

FIG. 4A is a schematic diagram of an apparatus including a capacitive touch system having a touch controller with integrated radio frequency (RF) identification (RFID) read capabilities, according to one or more examples;

FIG. 4B is a schematic diagram of an apparatus including a capacitive touch system having a touch controller with integrated RFID read capabilities, according to one or more examples;

FIGS. 5, 6, 7, and 8 are various conceptual level diagrams of an apparatus comprising a computing device having a capacitive touch system that utilizes the circuit arrangements and methodologies of FIGS. 4A and 4B, according to one or more examples;

FIG. 9 is a flowchart of a method of processing signals by a touch controller of a capacitive touch system of a computing device, according to one or more examples;

FIG. 10 is a flowchart of a method of processing signals by a touch controller of a capacitive touch system of a computing device, according to one or more examples;

FIG. 11 is an illustrative depiction of a computing device having a touchscreen of a capacitive touch system, according to one or more examples;

FIG. 12 depicts a conceptual level diagram of the PoS device of FIG. 1 which includes the capacitive touch system of FIG. 2 that is known by the inventors of this disclosure;

FIG. 13 is a schematic diagram of an acquisition front end circuit including a driver circuit and a sense circuit for describing touch detection at a sensor node;

FIG. 14A is a graph of a drive signal for driving sensor electrodes for touch detection based on mutual capacitance measurements, according to one or more examples;

FIG. 14B is a graph of a drive signal for driving sensor electrodes for touch detection based on self-capacitance measurements, according to one or more examples; and

FIG. 15 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples in which the present disclosure may be practiced. These examples are described in sufficient detail to enable a person of ordinary skill in the art to practice the present disclosure. However, other examples enabled herein may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an examples or this disclosure to the specified components, steps, features, functions, or the like.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples. While the various aspects of the examples may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the examples disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be rearranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Point of Sale (PoS) systems include PoS devices used to process POS transactions for businesses (e.g., for in-person transactions). Many PoS devices include touchscreens to display information and receive user input to facilitate these transactions using payment cards of consumers.

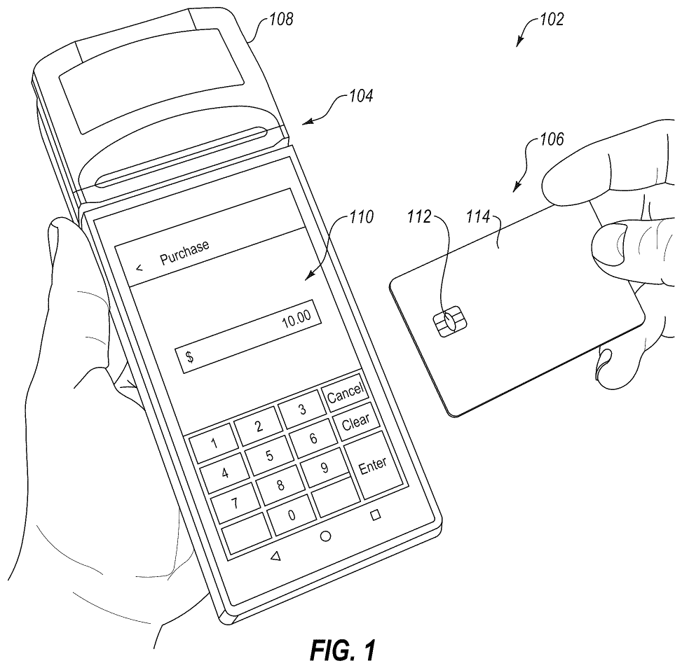

To illustrate, FIG. 1 depicts a PoS system 102 including a PoS device 104 for processing PoS transactions. PoS device 104 includes a touchscreen 110 of a capacitive touch system, which is carried in a housing 108. Touchscreen 110 is to display information (e.g., information regarding a pending transaction) and to receive user input from a user. In the example of FIG. 1, the display of touchscreen 110 displays textual information (e.g., “Purchase”) and visual user prompts (e.g., an input field for entry of a dollar amount ($10.00), numeric keys for touch entry of digits, and so on). The user input is received in the form of capacitive touch signals associated with user touches at a touch surface of touchscreen 110.

PoS device 104 also includes a radio frequency (RF) identification (RFID) reader contained within housing 108. The RFID reader of PoS device 104 is operative to facilitate transactions in relation to a payment or transaction card 106 (e.g., a credit or debit card). Transaction card 106 comprises a plastic card or carrier 114 that carries an RFID tag 112. RFID tag 112 may include at least two parts, including an antenna to receive and transmit RF signals and an RFID chip (e.g., an IC including non-volatile memory and logic) to store RFID data.

In general, PoS device 104 facilitates a contactless payment method where transaction card 106 communicates wirelessly with the RFID reader of PoS device 104 (e.g., as an alternative to obtaining information from an insertion of transaction card 106 or swipe of a magnetic strip on transaction card 106). When transaction card 106 is placed in close proximity to an RFID antenna of the RFID reader, the RFID reader detects and reads information stored in RFID tag 112. The RFID data or information read from RFID tag 112 may be associated with the cardholder (e.g., the information may be or include a unique identifier or a card serial number (CSN), which is a unique code to link to account details of the cardholder). PoS device 104 then communicates the information via the system for processing the transaction. Thus, POS system 102 allows a consumer to simply “tap” or “wave” transaction card 106 near PoS device 104, which picks up a radio signal from RFID tag 112 to obtain payment information, without the need to swipe or insert transaction card 106 in PoS device 104.

Note that PoS device 104 is merely one example type of computing device or terminal that may be utilized in one or more examples of the disclosure. Another example type of computing device or terminal that may be utilized is an access control device (e.g., a door entry device) of an access control system (e.g., a door entry system), where transaction card 106 is an access control card (or “proximity card”) having identification information stored in RFID tag 112. In one or more examples, the identification information may be or include a user identification (ID) of a user, a cardholder ID of the user, and/or a facility code indicating a location or facility associated with the card. Even another example type of computing device or terminal that may be utilized is an asset tracking device or terminal of an asset tracking system. In one or more examples, the computing device or terminal may be a portable, battery-powered computing device which is supplied power for operation using one or more batteries or battery pack.

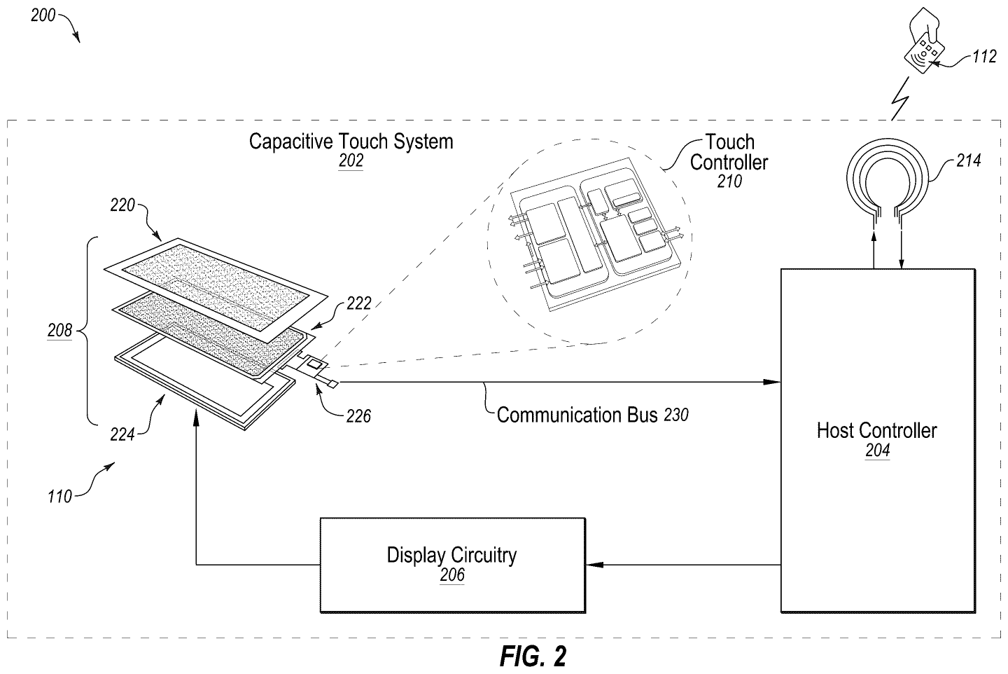

FIG. 2 depicts an apparatus 200 including a capacitive touch system 202 that is known by the inventors of this disclosure. In one or more examples, apparatus 200 comprises a computing device or terminal, such as PoS device 104 of FIG. 1.

Capacitive touch system 202 includes touchscreen 110, a display circuitry 206, and a host controller 204. In general, touchscreen 110 comprises a multi-layered input/output (I/O) device 208, including a touch controller 210. Multi-layered I/O device 208 comprises one or more layers of a front panel 220, one or more layers of a touch sensor 222, and one or more layers of a display 224. In multi-layered I/O device 208, front panel 220 is overlaid on top of touch sensor 222, which is overlaid on top of display 224.

In one or more examples of FIG. 2, touch controller 210 is mounted on and electrically connected to a flexible cable 226, and shown in an enlarged view in an oval window for better clarity. Multi-layered I/O device 208 of touchscreen 110 is operably coupled to touch controller 210 via flexible cable 226. In particular, touch sensor 222 is operably coupled to touch controller 210 for capacitive touch detection. Touch controller 210 is also coupled to host controller 204 via a communication bus 230 via flexible cable 226. Communication bus 230 may be any suitable type of communication bus, such as an Inter-Integrated Circuit (I2C) bus, a Universal Serial Bus (USB), or a Serial Peripheral Interface (SPI) bus, without limitation. Display 224 is operably coupled to display circuitry 206, which is operably coupled to host controller 204. Display 224 may be any suitable type of display, such as a liquid crystal display (LCD), an Organic Light-Emitting Diode (OLED) display, or an Active Matrix Organic Light Emitting Diode (AMOLED) display, without limitation.

Touch controller 210 includes (e.g., dedicated) processing circuitry for processing signals of touch sensor 222 of multi-layered I/O device 208. For example, touch controller 210 is to receive raw data associated with any capacitance changes at touch sensor 222 (i.e., from user touches) to process the raw data to determine location(s) and/or state(s) of any detected touch inputs, and to translate that data into detected touch position data (e.g., detected x-y touch positions). Touch controller 210 communicates the detected touch position data to host controller 204 over communication bus 230. Host controller 204 may receive and respond to the detected touch position data by performing operations or functions associated with the detected touch position data.

Host controller 204 is considered to be the main or primary controller of the device, and therefore operates to control one or more main or primary operations of the device. Main or primary operations of the device may include performing functions associated with application-specific processing of the device (e.g., functions associated with financial transaction processing, access control or door entry processing, asset tracking processing, and so on), communicating signals to display circuitry 206 for displaying information in display 224, receiving detected touch position data via touch sensor 222, and performing functions in response to the same.

In one conventional approach, such as that depicted in FIG. 2, an RFID antenna 214 is operably connected to host controller 204. Here, host controller 204 may serve as an RFID reader for processing transactions of the device. In this approach, host controller 204 may generate an RF signal from RFID antenna 214 to activate RFID tag 112. When RFID tag 112 is activated, RFID data from RFID tag 112 (e.g., information associated with the cardholder) may be detected. Host controller 204 may communicate the detected information via the system for processing the transaction.

As is apparent, apparatus 200 utilizes touch controller 210 for touch sensor detection and (a separate) host controller 204 including RFID antenna 214 for RFID reading. It is not uncommon for a product designer/manufacturer that requires a touch controller, or a touchscreen including a touch controller, in the design/manufacture of a product (e.g., PoS device 104 of FIG. 1), to design and use their own RFID reader or use a third-party RFID reader in the product. Such an approach, however, undesirably increases design complexity and bill of materials (BOM) of the product. The overall design/manufacture of the product may be considered somewhat inefficient, as already existing and required circuitry of touch controller 210 may be underutilized and available for other uses.

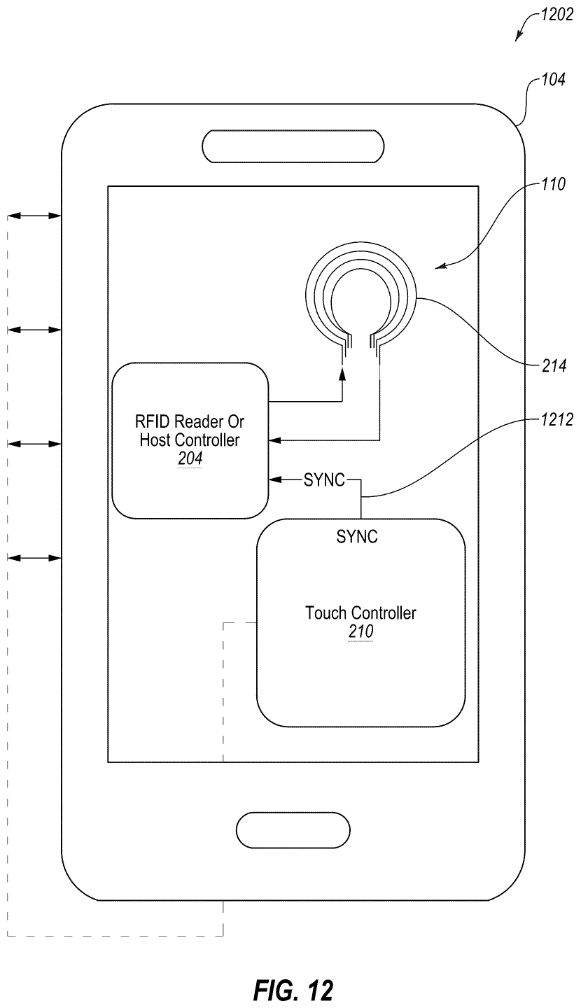

Also, in the arrangement of FIG. 2, scanning for RFID tags by host controller 204 using RFID antenna 214 may interfere with the scanning of touch sensor 222 by touch controller 210. To prevent such noise injection, touch controller 210 may provide a synchronization input to receive synchronization (SYNC) signals from host controller 204 (e.g., as shown and described later in relation to FIG. 12). Here, synchronization signals may be used to coordinate touch sensor scanning operations relative to RFID scanning operations. Unfortunately, relatively slow processing and/or poor coordination of these processes could lead to reduced, limited, or intermittent RFID or touch sensor scanning, and this could further lead to interruptions or inconsistencies in device operation.

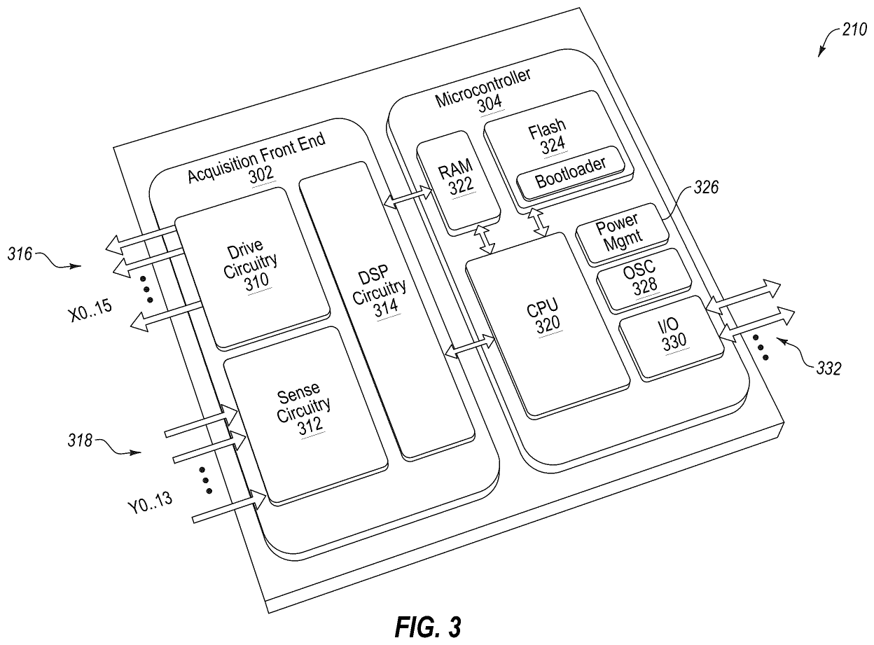

FIG. 3 is a schematic block diagram of touch controller 210 (FIG. 2) in a conventional circuit arrangement. In one or more examples, touch controller 210 of FIG. 3 includes an acquisition front end 302 and a microcontroller 304. Acquisition front end 302 includes a drive circuitry 310, a sense circuitry 312, and a digital signal processing (DSP) circuitry 314 (e.g., a DSP processing and control circuitry). Microcontroller 304 includes a central processing unit (CPU) 320, an oscillator 328, an I/O interface circuitry 330 for one or more communication buses 332, and a power management module 326. One or more clock signals may be generated from oscillator 328 and used for timing of circuitry (e.g., CPU 320, DSP circuitry 314, and so on). Microcontroller 304 also includes memory, including RAM 322 and flash memory 324 (e.g., including a bootloader process). In one or more examples, an application is stored in flash memory 324 for controlling operation of CPU 320 and/or DSP circuitry 314.

In one or more examples, all or most of the components of touch controller 210 are provided in IC, as a touch controller IC, for use in a computing device or terminal (e.g., PoS device 104 of FIG. 1). In one or more examples, touch controller 210 is configured with a circuit design based on a maXTouch® touch controller. maXTouch® is a registered trademark of Microchip Technology Incorporated, of Chandler, Arizona, USA.

In one or more examples, touch controller 210 includes acquisition front end 302 for processing signals of a touch sensor. Here, DSP circuitry 314 is operably coupled to drive circuitry 310, and drive circuitry 310 is coupled to a number of drive lines 316. In one or more examples, drive circuitry 310 is referred to as transmit (Tx) circuitry and the number of drive lines 316 is referred to as a number of transmit lines. In one or more examples of FIG. 3, the number of drive lines 316 includes sixteen (16) drive lines, which are designated in the figure as X0 through X15. DSP circuitry 314 is also operably coupled to sense circuitry 312, and sense circuitry 312 is coupled to a number of sense lines 318. In one or more examples, sense circuitry 312 is referred to as receiver (Rx) circuitry and the number of sense lines 318 is referred to as a number of receive lines. In one or more examples of FIG. 3, the number of sense lines 318 includes fourteen (14) sense lines, which are designated in the figure as Y0 through Y13. In one or more examples, the number of drive lines 316 is provided as output pins of the touch controller IC, and the number of sense lines 318 is provided as input pins of the touch controller IC. In one or more examples, I/O interface circuitry 330 may be coupled to output pins (e.g., provided with one or more connectors).

According to one or more examples of the disclosure, the touch controller is configured to execute both touch sensor processes for touch detection and RFID read processes for RFID data detection. In one or more examples, the overall design of a computing device (e.g., a PoS device) is made more efficient by leveraging the (e.g., already existing and required) circuitry of the touch controller (e.g., acquisition front end and DSP circuitry) for extended use in RFID reading. As a result, the complexity and the cost of a computing device may be reduced. The integrated solution may reduce the BoM of a product for product designers/manufacturers using a touch controller or touchscreen. In one or more examples, processes for touch sensor scanning and RFID scanning, now performed by the same touch controller entity, may be more easily managed, and made faster and/or more efficient.

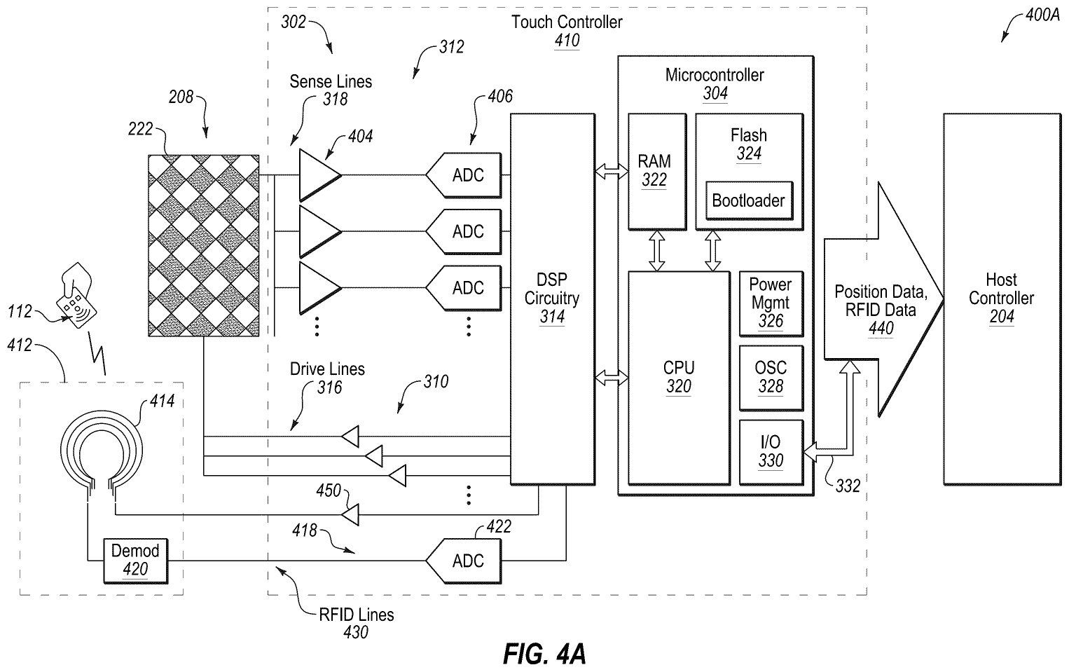

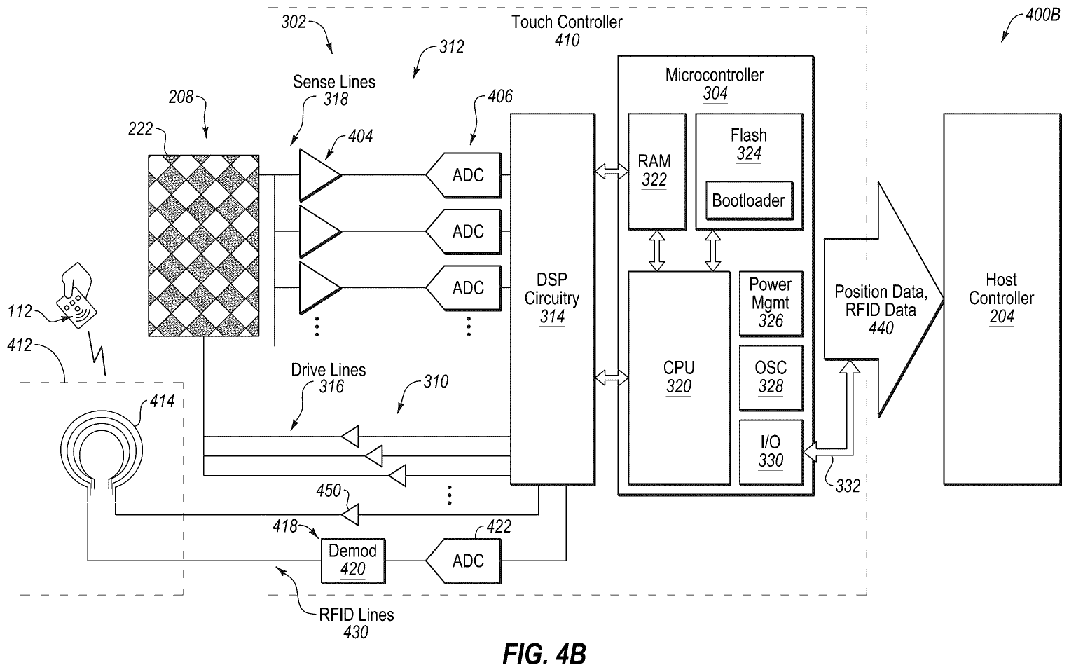

FIG. 4A is a schematic diagram of an apparatus 400A including a capacitive touch system having a touch controller 410 with integrated RFID read capabilities, according to one or more examples. Some of the features in FIG. 4A are the same as or similar to some of the features in FIGS. 2 and 3, as indicated by the same reference numbers, unless expressly described otherwise. In one or more examples, apparatus 400A of FIG. 4A is a computing device or terminal, such as PoS device 104 of FIG. 1. The capacitive touch system of apparatus 400A may include some of the basic components of capacitive touch system 202 of FIG. 2, including the touchscreen (e.g., multi-layered I/O device 208 including at least touch sensor 222), the display circuitry (e.g., display circuitry 206 of FIG. 2), and host controller 204.

In one or more examples, touch controller 410 includes acquisition front end 302 for processing signals of touch sensor 222 for touch detection. In one or more examples, touch sensor 222 may include an array or grid of electrodes arranged in rows and columns. Each intersection point between a row and a column of electrodes may form a (capacitive) sensor node. The electrodes may be divided into two sets; a first set coupled to the number of drive lines 316 (e.g., rows or x-lines) of touch controller 410 and a second set coupled to the number of sense lines 318 (e.g., columns or y-lines) of touch controller 410. In one or more examples, drive circuitry 310 may be connected to the rows or x-lines (e.g., X0-X15 for rows 1-15), and sense circuitry 312 may be connected to the columns or y-lines (e.g., Y0-Y13 for columns 1-13).

In one or more examples, drive circuitry 310 includes a number of driver circuits 310 respectively associated with the number of drive lines 316. In one or more examples, sense circuitry 312 includes a number of buffer circuits 404 (or, alternatively, for example, driver amplifier circuits or transimpedance amplifier circuits) and a number of analog-to-digital converters (ADCs) 406. The number of buffer circuits 404 is respectively associated with the number of sense lines 318. The number of buffer circuits 404 is respectively coupled to the number of ADCs 406, which are respectively coupled to inputs of DSP circuitry 314.

In an example operation, touch controller 410 may drive an electrical signal (or a “drive signal”) at each row of a sensor node of touch sensor 222, e.g., sequentially, via the number of drive lines 316 using drive circuitry 310. The drive signal may be any suitable electrical signal, frequency signal, square wave, series of bursts or pulses, alternating voltage or current signals, and so on. Sense circuitry 312 may measure a mutual capacitance, for example, at each column of a sensor node of touch sensor 222, e.g., sequentially, via the number of sense lines 318. Based on the measurements, DSP circuitry 314 may detect changes in capacitance to detect a location of a touch.

Thus, when a conductive object, such as a finger, approaches the touchscreen and makes contact with the surface thereof, the finger may form a capacitive coupling between row and column electrodes at the point of touch, altering the capacitance at the corresponding intersection point. The sense lines may measure the capacitance of each of the column electrodes simultaneously. The capacitance may then be analyzed by DSP circuitry 314 to determine the touch position data (e.g., the location of the touch), which may be communicated to CPU 320 and/or RAM 322 of microcontroller 304. In one or more examples, microcontroller 304 uses I/O interface circuitry 330 to communicate, at a communication process 440, the detected touch position data to host controller 204 via communication bus 332.

In one or more specific examples, apparatus 400A, comprising the capacitive touch system, may utilize one or more microsequencers for processing. For example, the capacitive touch system may utilize at least two microsequencers including a first microsequencer and a second microsequencer. The first microsequencer may handle all of measurement sequences including, but not limited to, transmit waveform and timing as well as receive configuration and signal conversion. The second microsequencer may manage signal processing including, but not limited to, signal reconstruction, delta computation and flag generation.

In one or more examples, touch controller 410 also includes a portion of acquisition front end 302 adapted to operate with an RFID antenna circuitry 412 for RFID data detection. The portion of acquisition front end 302 and RFID antenna circuitry 412 may comprise an RFID reader adapted to read RFID data from RFID tag 112. In one or more examples, RFID antenna circuitry 412 includes at least an RFID antenna 414.

In one or more specific examples of FIG. 4A, RFID antenna circuitry 412 includes RFID antenna 414 and a demodulator 420. Demodulator 420, which is external to touch controller 410, is coupled to RFID antenna 414 and acquisition front end 302 of touch controller 410. In one or more specific examples, one or more control signal lines (e.g., an enable line, and/or a clock or synchronization signal line) from touch controller 410 may be coupled to demodulator 420. In one or more further examples, RFID antenna circuitry 412 includes additional or alternative circuitry, such as resonant circuitry, matching network circuitry, and so on.

In one or more examples, RFID antenna 414 is designed and integrated in multi-layered I/O device 208 having touch sensor 222 (e.g., in or on touch sensor 222). In a specific, non-limiting example, RFID antenna 414 is formed of conductive material on one or more layers of touch sensor 222. In one or more examples, RFID antenna 414 is located within a touchscreen area of the touchscreen (e.g., RFID tags may be read at the touch surface area). In one or more alternative examples, RFID antenna 414 is provided at a location of the device outside of the touchscreen area of the touchscreen (e.g., RFID tags may be read outside of the touch surface area).

Touch controller 410 includes RFID lines 430 (e.g., input and output lines or pins) for coupling to RFID antenna circuitry 412 (e.g., RFID antenna 414). RFID lines 430 include an RFID antenna transmit line for coupling to RFID antenna 414. RFID lines 430 also include an RFID antenna receive line for coupling to demodulator 420. In one or more examples, RFID lines 430 may be, or be selected from, available auxiliary lines of touch controller 410. In one or more examples, RFID lines 430 of touch controller 410 are dedicated lines for interfacing with RFID antenna circuitry 412.

In one or more examples, drive circuitry 310 of touch controller 410 includes an RFID antenna driver circuit 450 coupled to the RFID antenna transmit line of RFID lines 430. Touch controller 410 includes an RFID antenna sense circuit 418 including at least an ADC 422 coupled to the RFID antenna receive line of RFID lines 430. More particularly, an output of demodulator 420 is coupled to an input of RFID antenna sense circuit 418 (e.g., ADC 422) via the RFID antenna receive line of touch controller 410, and an output of RFID antenna sense circuit 418 is coupled to an input of DSP circuitry 314.

In an example operation, DSP circuitry 314 controls RFID antenna driver circuit 450 to generate an RF signal for transmission from RFID antenna 414. When RFID tag 112 is in proximity, the RF signal activates RFID tag 112 to produce a modulated RF signal modulated according to RFID data of RFID tag 112. The modulated RF signal is received via RFID antenna 414. In one or more examples, the modulated RF signal is a binary-coded RF signal (i.e., modulated with 0's or 1's) that is modulated according to Amplitude Shift Keying (ASK) (e.g., in the form of On-Off Keying (OOK)) or Frequency Shift Keying (FSK), as a few examples. The modulated RF signal is demodulated by demodulator 420 of RFID antenna circuitry 412. The demodulated signal is received at the RFID antenna receive line of touch controller 410. RFID antenna sense circuit 418 including ADC 422 is used to detect the RFID data (e.g., digital 0's or 1's), which are provided at an output of ADC 422. DSP circuitry 314 receives, detects, and further processes the RFID data (e.g., detecting the unique code, identifier, or number). DSP circuitry 314 may send the RFID data (e.g., the unique code, identifier, or number) to microcontroller 304.

In one or more examples, touch controller 410 may generate the RF signal from RFID antenna 414 at a frequency that is based on a clock signal generated from oscillator 328. In a specific, non-limiting example, touch controller 410 may generate the modulated signal to RFID antenna 414 at a frequency of 13.56 Megahertz (MHz) according to the Near-Field Communication (NFC) standard (e.g., International Organization for Standardization (ISO)/International Electrotechnical Commission (IEC) 18092). In one or more other various examples, touch controller 410 may utilize internal clock signals for output as Pulse Width Modulated (PWM) signals to drive RFID antenna 414. In one or more other examples, touch controller 410 may generate the RF signal from RFID antenna 414 at a frequency that is based on an external clock signal generated from an external oscillator different from oscillator 328. In one or more examples, touch controller 410 may receive and use the external clock signal as a reference clock for a timing reference.

In one or more examples, microcontroller 304 may use I/O interface circuitry 330 to communicate, at communication process 440, the RFID data (e.g., the unique code, identifier, or number) to host controller 204 via communication bus 332.

In one or more other examples, microcontroller 304 may encrypt the RFID data (e.g., the unique code, identifier, or number) to generate an encrypted RFID data (e.g., an encrypted unique code, identifier, or number) and communicate the encrypted RFID data to host controller 204 via communication bus 332.

In one or more other examples, microcontroller 304 may determine whether the RFID data meets one or more predetermined criteria. Here, microcontroller 304 may provide a trigger pulse to host controller 204 responsive to the RFID data meeting the one or more predetermined criteria, and may communicate the RFID data to host controller 204 via communication bus 332 responsive to providing the trigger pulse (e.g., host controller 204 may retrieve the data from touch controller 410 responsive to the trigger pulse).

In one or more examples, touch controller 410 may, prior to generating the RF signal for transmission from RFID antenna 414 in an RFID scan, pause one or more scanning operations used to receive the capacitance signals from touch sensor 222. After completion of the RFID scan, touch controller 410 may resume one or more scanning operations used to receive the capacitance signals from touch sensor 222.

In one or more examples, touch controller 410 may operate to regularly perform one or more scanning operations used to receive the capacitance signals from touch sensor 222 and, conversely, normally refrain from perform scanning for RFID tags. In this example approach, touch controller 410 may drive the modulated signal to the RFID antenna in an RFID scan (e.g., only) responsive to detecting presence, at touch sensor 222 (or touchscreen), of a transaction card that carries the RFID tag. Prior to generating the RF signal for transmission from RFID antenna 414 in the RFID scan, touch controller 410 may pause one or more scanning operations used to receive the capacitance signals from touch sensor 222. After completion of the RFID scan, touch controller 410 may resume one or more scanning operations used to receive the capacitance signals from touch sensor 222.

In one or more other examples, touch controller 410 may allow host controller 204 to store identifiers at touch controller 410 (e.g., stored in a portion of flash memory 324) for placement on an “accepted list” of accepted identifiers. Once stored, new identifiers from new RFID reads may be compared against accepted identifiers in the accepted list for validation. In a specific, non-limiting example, touch controller 410 may receive, from host controller 204 (e.g., via communication bus 332), a number of identification numbers and store the number of identification numbers in memory. Touch controller 410 may compare a detected identification number (i.e., detected from a new RFID read) with respective ones of the number of identification numbers stored in the memory. Touch controller 410 may communicate the detected identification number to host controller 204 at least partially responsive to a match between the detected identification number and one of the number of identification numbers stored in the memory. On the other hand, touch controller 410 may refrain from communicating the detected identification number to host controller 204 based on a mismatch between the detected identification number and one of the number of identification numbers stored in the memory.

FIG. 4B is a schematic diagram of an apparatus 400B including a capacitive touch system having touch controller 410 with integrated RFID read capabilities, according to one or more examples. Most of the features in FIG. 4B are the same as or similar to the features in FIG. 4A, as indicated by the same reference numbers, except for the following differences in RFID antenna circuitry 412 and acquisition front end 302. In the one or more specific examples of FIG. 4B, RFID antenna circuitry 412 including RFID antenna 414 is external to touch controller 410, and demodulator 420 is arranged within touch controller 410 (e.g., as part of RFID antenna sense circuit 418). Here, RFID antenna 414 is coupled to demodulator 420 via the RFID antenna receive line of touch controller 410, an output of demodulator 420 is coupled to an input of ADC 422, and an output of ADC 422 is coupled to an input of DSP circuitry 314.

In an example operation, DSP circuitry 314 controls RFID antenna driver circuit 450 to generate an RF signal for transmission from RFID antenna 414. When RFID tag 112 is in proximity, the RF signal activates RFID tag 112 to produce a modulated RF signal modulated according to RFID data of RFID tag 112. The modulated RF signal is received via RFID antenna 414. In one or more examples, the modulated RF signal is a binary-coded RF signal (i.e., modulated with 0's or 1's) that is modulated according to ASK (e.g., in the form of OOK) or FSK, as a few examples. The modulated RF signal is received at the RFID antenna receive line of touch controller 410. The modulated RF signal is demodulated by demodulator 420 of touch controller 410. ADC 422 is used to detect the RFID data (e.g., digital 0's or 1's), which are provided at an output of ADC 422. DSP circuitry 314 receives, detects, and further processes the RFID data (e.g., detecting the unique code, identifier, or number). DSP circuitry 314 may send the RFID data (e.g., the unique code, identifier, or number) to microcontroller 304.

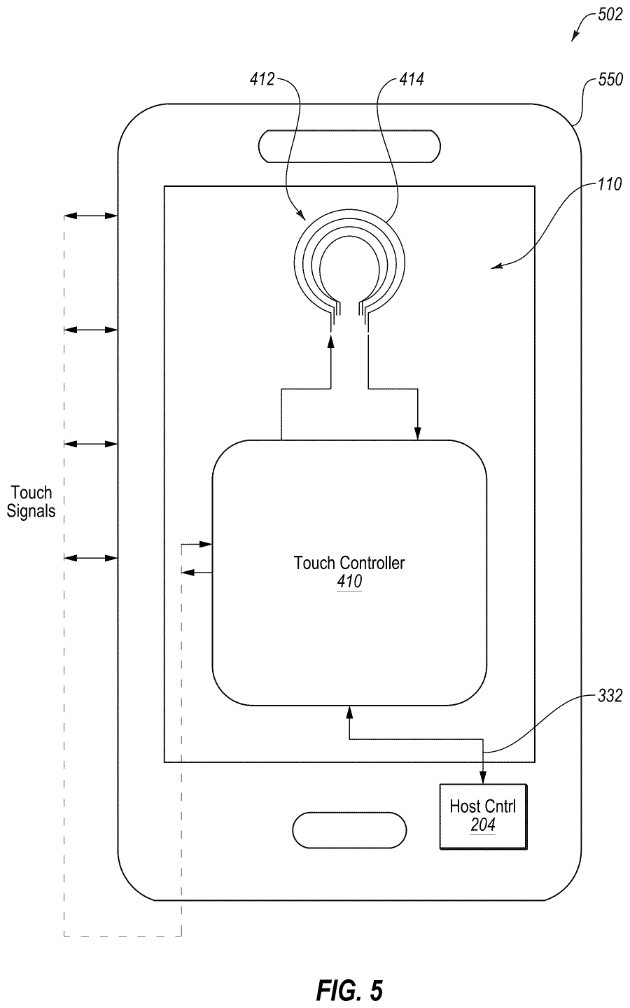

FIGS. 5, 6, 7, and 8 are various conceptual level diagrams of an apparatus comprising a computing device (e.g., PoS device 104 of FIG. 1) having a capacitive touch system that utilizes the circuit arrangements and methodologies of FIGS. 4A and 4B, according to one or more examples. Although various components of the capacitive touch systems of FIGS. 5, 6, and 7 are depicted, for illustrative purposes, as positioned (e.g., and viewable) at the touch surface of touchscreen 110, within or outside of the touchscreen region, the components may actually be positioned behind (e.g., and hidden), within, and/or adjacent touchscreen 110.

FIG. 5 is a conceptual level diagram 502 of a computing device 550 having touchscreen 110 of the capacitive touch system, according to one or more examples. In FIG. 5, touch controller 410 is shown coupled to lines for detecting touch signals, coupled to RFID antenna 414 for RFID reading, and coupled to host controller 204 via communication bus 332 for communicating touch position data and RFID data to host controller 204.

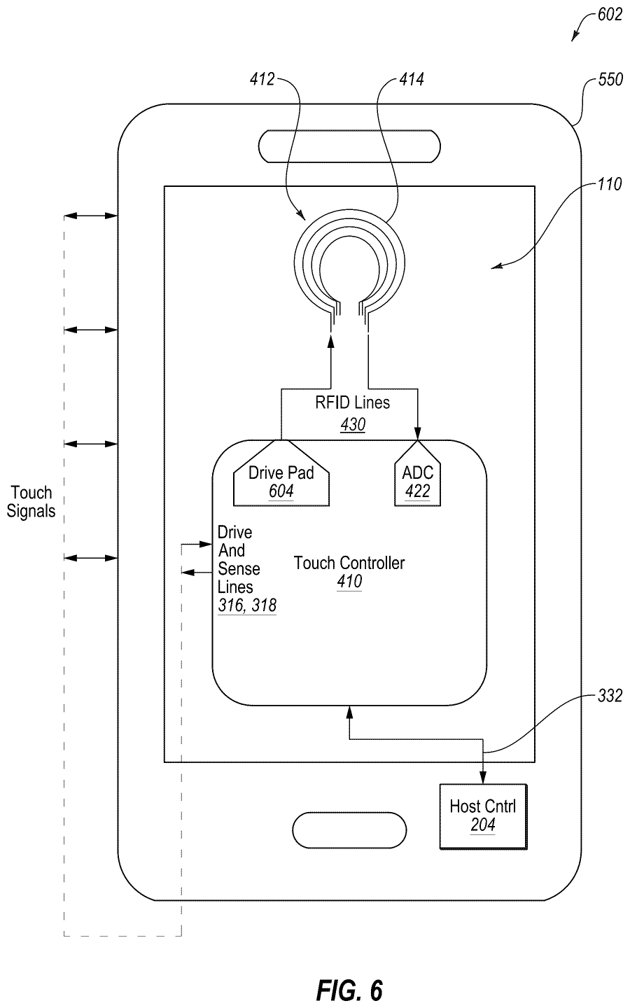

FIG. 6 is a conceptual level diagram 602 of computing device 550 having touchscreen 110 of the capacitive touch system, according to one or more examples. Conceptual level diagram 602 of FIG. 6 is the same as conceptual level diagram 502 of FIG. 5, but further depicting drive and sense lines 316 and 318, respectively, of touch controller 410 for detecting touch signals, and RFID lines 430 of touch controller 410 for coupling to RFID antenna 414 (e.g., a drive pad 604 coupled to the RFID antenna transmit line of RFID lines 430, and ADC 422 coupled to the RFID antenna receive line of RFID lines 430).

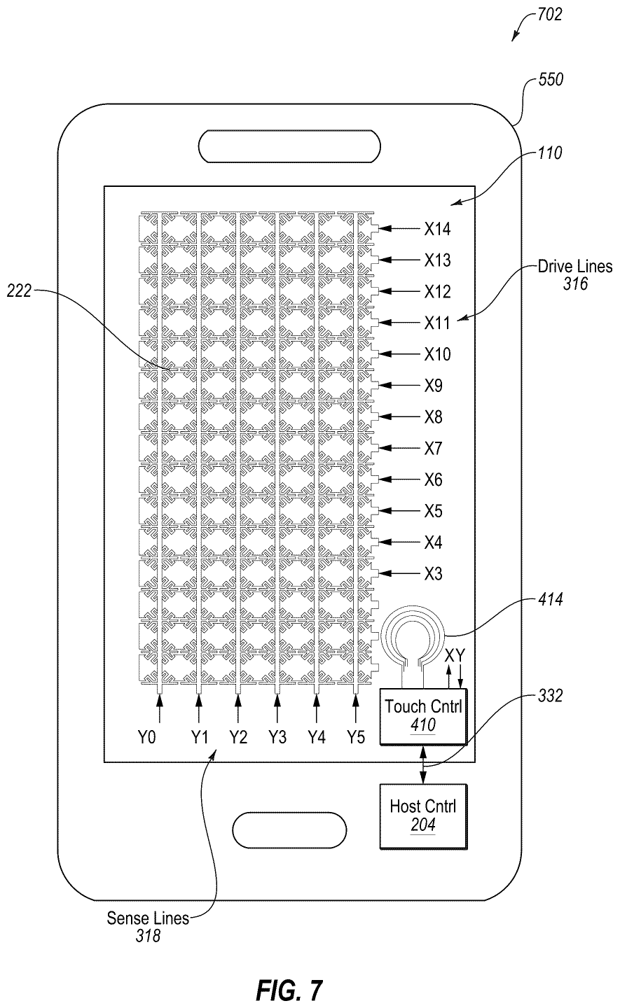

FIG. 7 is a conceptual level diagram 702 of computing device 550 having touchscreen 110 of the capacitive touch system, according to one or more examples. Conceptual level diagram 702 of FIG. 7 depicts touch sensor 222 arranged across the entire region of touchscreen 110, with touch sensor 222 coupled to the number of drive lines 316 of touch controller 410 and the number of sense lines 318 of touch controller 410, for the detection of touch signals. Again, touch controller 410 is shown coupled to RFID antenna 414 for RFID reading, and coupled to host controller 204 via communication bus 332 for communicating touch position data and RFID data to host controller 204.

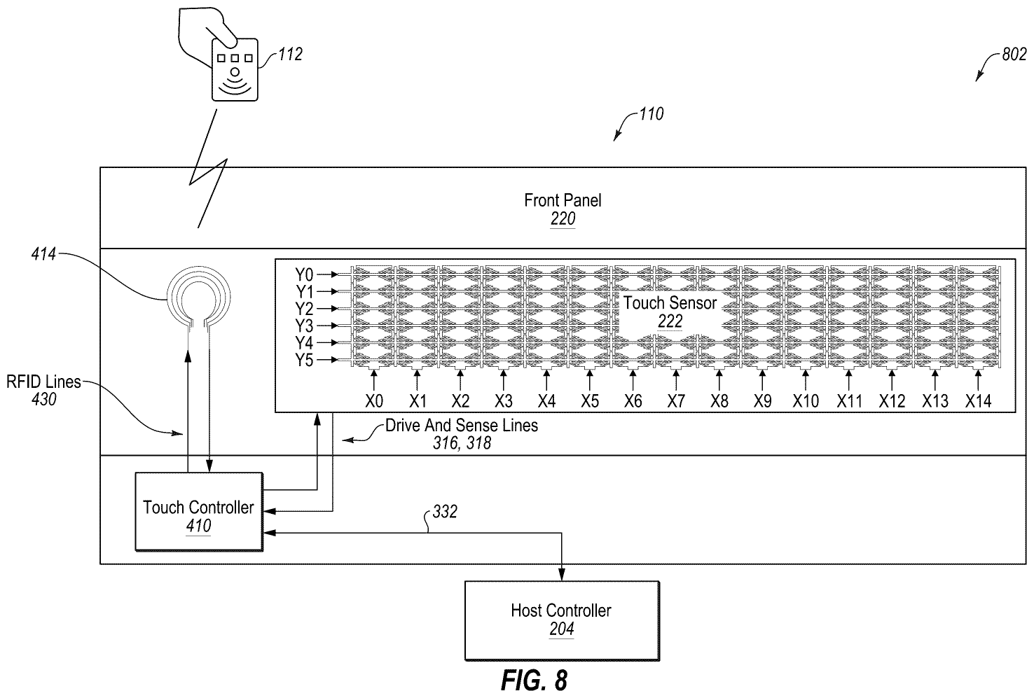

FIG. 8 is a conceptual level diagram 802 of computing device 550 having touchscreen 110 of the capacitive touch system, according to one or more examples. Conceptual level diagram 802 of FIG. 8 is similar to conceptual level diagram 702 of FIG. 7, but shown in a cross-sectional side view. Again, in FIG. 8, touch controller 410 is shown coupled to touch sensor 222 via drive and sense lines 316 and 318, respectively, for detecting touch signals, coupled to RFID antenna 414 for RFID reading, and coupled to host controller 204 via communication bus 332 for communicating touch position data and RFID data to host controller 204.

In one or more examples of FIG. 8, RFID antenna 414 is designed and integrated as part of touchscreen 110 (e.g., in or on touch sensor 222). In a specific, non-limiting example, RFID antenna 414 is formed of conductive material on one or more layers of touch sensor 222. In one or more examples, RFID antenna 414 is located within a touchscreen area of the touchscreen of the device (e.g., RFID tags may be read at the touch surface area). In one or more specific examples, RFID antenna 414, comprising the conductive material on one or more layers of touch sensor 222, is suitable for connection to touch controller 410 (e.g., in the same or similar manner as drive and sense lines 316 and 318, respectively). In one or more alternative examples, RFID antenna 414 is provided at a location of the device outside of the touchscreen area of the touchscreen (e.g., RFID tags may be read outside the touch surface area).

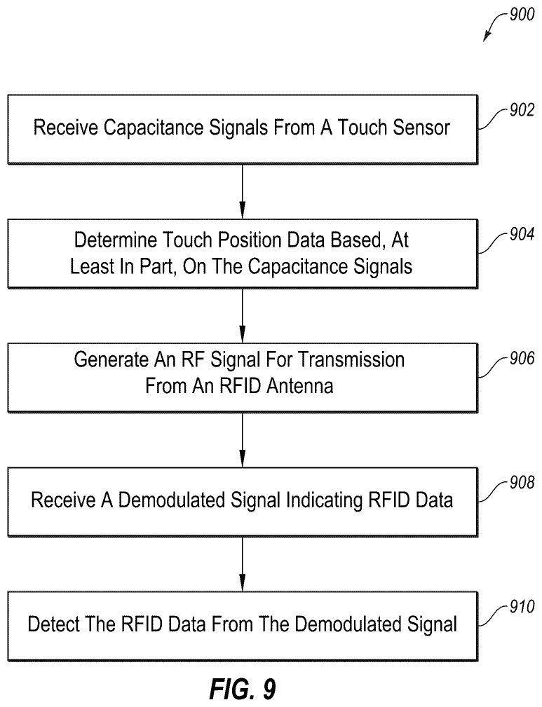

FIG. 9 is a flowchart of a method 900 of processing signals by a touch controller of a capacitive touch system of a computing device, according to one or more examples. In one or more examples, method 900 may be performed by touch controller 410 of the capacitive touch system of apparatus 400A of FIG. 4A.

At an act 902, capacitance signals from a touch sensor are received. At an act 904, touch position data are determined based, at least in part, on the capacitance signals. At an act 906, an RF signal is generated for transmission from an RFID antenna. The RF signal is to activate an RFID tag (e.g., located within proximity of the RFID antenna) to produce a modulated RF signal modulated according to RFID data of the RFID tag. At an act 908, a demodulated signal indicates the RFID data is received. The demodulated signal is demodulated from the modulated RF signal received from the RFID antenna. At an act 910, the RFID data is detected from the demodulated signal.

In one or more examples of method 900, the touch position data are communicated to a host controller. In one or more examples of method 900, the RFID data are also communicated to the host controller.

In one or more examples of method 900, the demodulated signal is received from a demodulator external to the touch controller. In one or more other examples, the modulated RF signal is received from the RFID antenna and demodulated in a demodulator within the touch controller to generate the demodulated signal.

In one or more examples of method 900, a presence of a transaction card that carries the RFID tag is detected at the touch sensor (or the touchscreen) and, at act 906, the modulated signal is generated at the RFID antenna at least partially responsive to the detected presence of the card. In one or more examples, prior to generating the RF signal for transmission from the RFID antenna in an RFID scan, one or more scanning operations used to receive the capacitance signals from the touch sensor are paused. In one or more examples, after completion of the RFID scan, the one or more scanning operations used to receive the capacitance signals from the touch sensor are resumed.

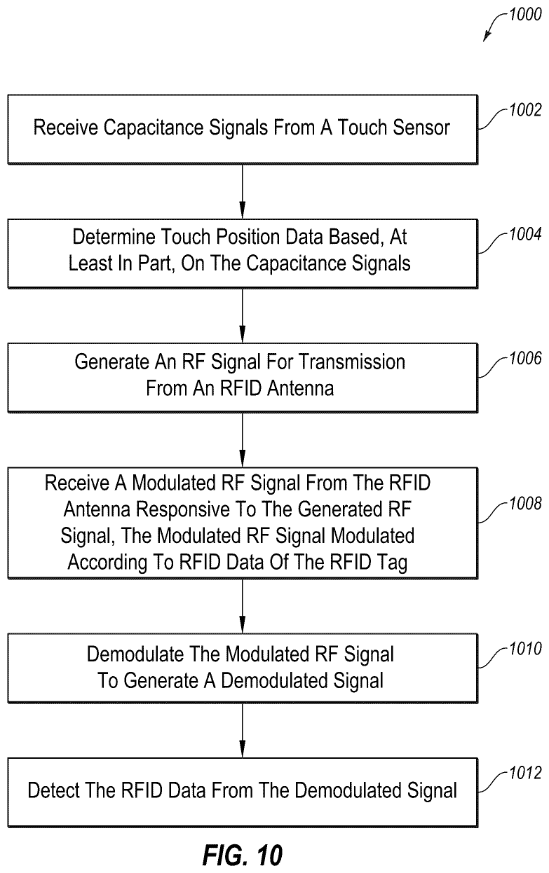

FIG. 10 is a flowchart of a method 1000 of processing signals by a touch controller of a capacitive touch system of a computing device, according to one or more examples. In one or more examples, method 900 may be performed by touch controller 410 of the capacitive touch system of apparatus 400B of FIG. 4B.

At an act 1002, capacitance signals from a touch sensor are received. At an act 1004, touch position data are determined based, at least in part, on the capacitance signals. At an act 1006, an RF signal is generated for transmission from the RFID antenna. At an act 1008, a modulated RF signal is received from the RFID antenna responsive to the generated RF signal. The modulated RF signal is modulated according to RFID data of an RFID tag (e.g., located within proximity of the RFID antenna) activated from the RF signal. At an act 1010, the modulated RF signal is demodulated to generate a demodulated signal. At an act 1012, the RFID data is detected from the demodulated signal.

In one or more examples of method 1000, the touch position data are communicated to a host controller. In one or more examples of method 1000, the RFID data are also communicated to the host controller.

In one or more examples of method 1000, the modulated RF signal is received at the touch controller and demodulated in a demodulator within the touch controller.

In one or more examples of method 1000, a presence of a transaction card that carries the RFID tag is detected at the touch sensor (or the touchscreen) and, at act 1006, the RF signal is generated for transmission from the RFID antenna at least partially responsive to the detected presence of the card. In one or more examples, prior to generating the RF signal for transmission from the RFID antenna in an RFID scan, one or more scanning operations used to receive the capacitance signals from the touch sensor are paused. In one or more examples, after completion of the RFID scan, the one or more scanning operations used to receive the capacitance signals from the touch sensor are resumed.

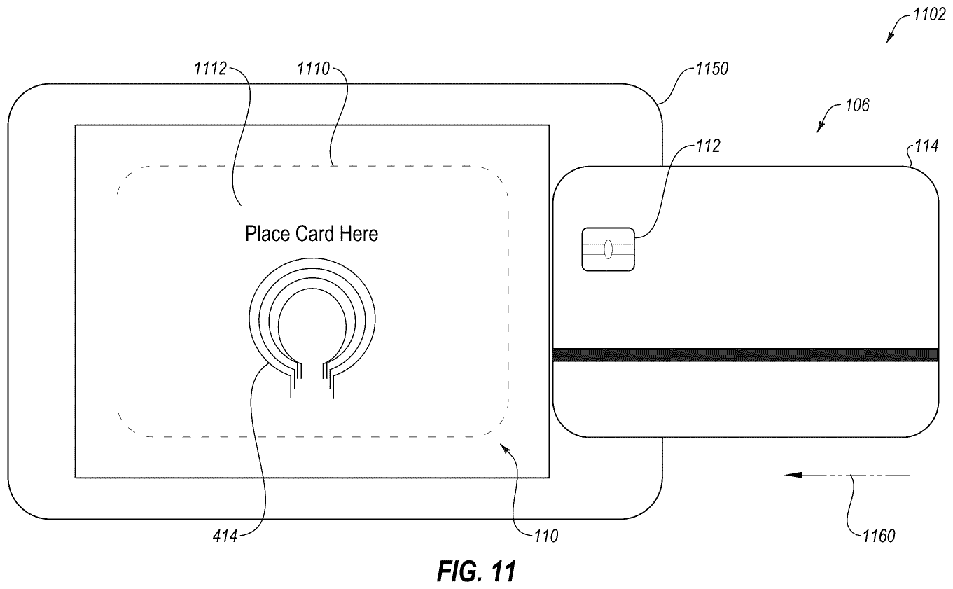

FIG. 11 is an illustrative diagram 1102 of a computing device 1150 having touchscreen 110 of a capacitive touch system, according to one or more examples. Computing device 1150 may operate using the circuit arrangements and methodologies of FIGS. 4A and 4B, while further managing touch sensor scans and RFID scans according to the following (e.g., a process to “trigger RFID scan responsive to detection of card presence”).

In one or more examples, the touch controller (e.g., touch controller 410 of FIG. 4A or 4B) of the capacitive touch system of computing device 1150 may operate to regularly perform scanning operations to receive capacitance signals from the touch sensor for touch detection. On the other hand, the touch controller of the capacitive touch system of computing device 1150 may normally refrain from perform scanning for RFID tags using RFID antenna 414. Rather, the touch controller may generate an RF signal for transmission from RFID antenna 414 in an RFID scan (e.g., only) in response to detecting presence, at touchscreen 110 (e.g., at the surface thereof), of transaction card 106 including RFID tag 112.

In one or more examples, touchscreen 110 of computing device 1150 may include a touchscreen card area 1110. Touchscreen card area 1110 is a touchscreen area within which transaction card 106 is to be positioned (e.g., according to a user positioning 1160) in order for the touch controller to detect transaction card 106 and trigger an RFID scan. RFID antenna 414 is located within touchscreen card area 1110. In one or more examples, touchscreen 110 may display one or more indications that outline or indicate, in part or in full, touchscreen card area 1110 within which to position transaction card 106 (e.g., such as the dashed lines indicated in FIG. 11). In one or more examples, touchscreen card area 1110 covers only a (e.g., relatively small) portion of the entire surface area of touchscreen 110. In one or more examples, touchscreen 110 may display one or more text indications 1112 (“Place Card Here”) to provide the user with a text instruction for positioning transaction card 106 within the appropriate touchscreen card area 1110.

In one or more examples, the touch controller may use the touch sensor to detect changes in capacitance of the nodes associated with touchscreen card area 1110 while transaction card 106 is positioned within touchscreen card area 1110. In one or more other examples, one or more additional or alternative sensors (e.g., a photoelectric sensor, a photoresistor, and so on, coupled to an input(s) of the touch controller) may be used to detect the presence of transaction card 106 within touchscreen card area 1110.

In one or more examples, prior to generating the RF signal for transmission from RFID antenna 414 in the RFID scan, the touch controller may pause one or more scanning operations used to receive the capacitance signals from the touch sensor. After completion of the RFID scan, the touch controller may resume one or more scanning operations used to receive the capacitance signals from the touch sensor.

FIG. 12 depicts a conceptual level diagram 1202 of PoS device 104 of FIG. 1, which includes capacitive touch system 202 of FIG. 2, which is known by the inventors of this disclosure. As previously discussed, scanning for RFID tags by host controller 204 using RFID antenna 214 may interfere with the scanning of the touch sensor by touch controller 210. To prevent such noise injection, touch controller 210 provides a synchronization input 1212 (“SYNC”) to receive synchronization signals from host controller 204. Here, synchronization signals may be used to coordinate touch sensor scanning operations relative to RFID scanning operations. For example, synchronization signals may be communicated from host controller 204 to touch controller 210 for allowing touch sensor scanning after RFID scanning is performed, or for preventing touch sensor scanning while RFID scanning is being performed. As mentioned earlier, relatively slow processing and/or poor coordination of these processes could lead to reduced, limited, or intermittent RFID or touch sensor scanning, and this could further lead to interruptions or inconsistencies in device operation.

According to one or more examples of the disclosure, using the circuit arrangement of touch controller 410 of FIG. 4A or 4B, and/or the methodology associated with method 900 of FIG. 9 or method 1000 of FIG. 10, and/or FIG. 11, the processes for touch sensor scanning and RFID scanning may be coordinated more easily, and made faster and/or more efficient, as the processes are now performed by the same touch controller entity. In one or more examples, the integrated solution may provide an increase in touch sensor scan rate and/or RFID scan rate, by removing the need to wait for synchronization signals. In one or more other examples, using synchronization signals to manage and/or coordinate touch sensor scanning and RFID scanning may no longer be needed. In one or more specific examples, since a transaction card may be detected when positioned near the touchscreen to trigger an RFID scan (e.g., FIG. 11), this may reduce the need for regular RFID scans which would reduce the power consumption of the device.

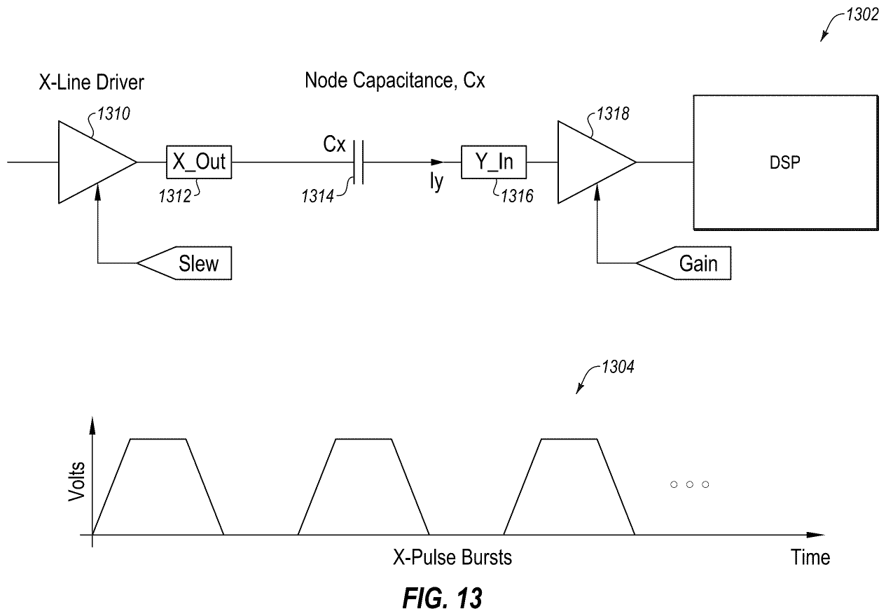

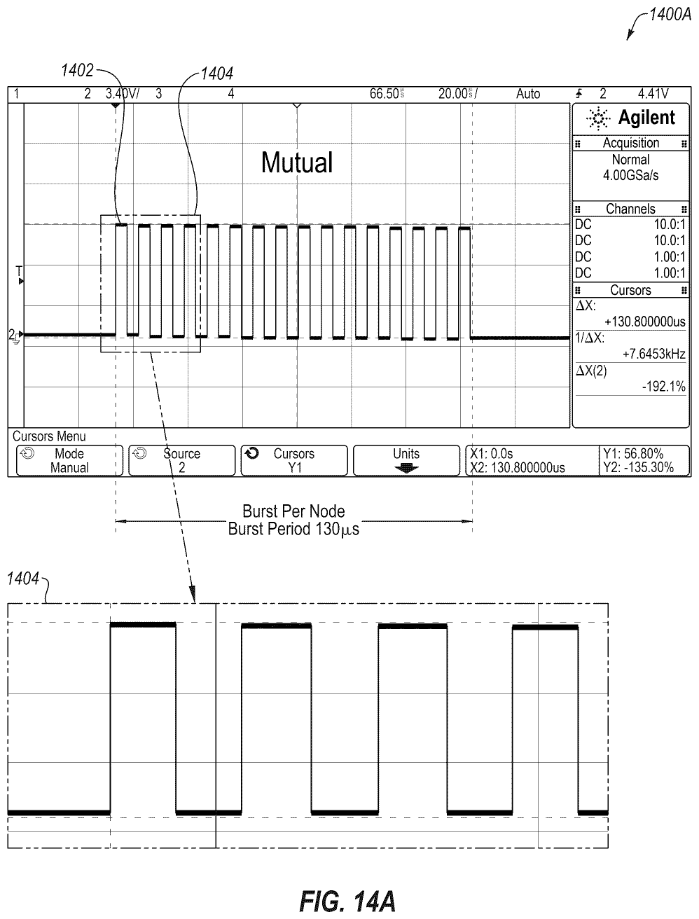

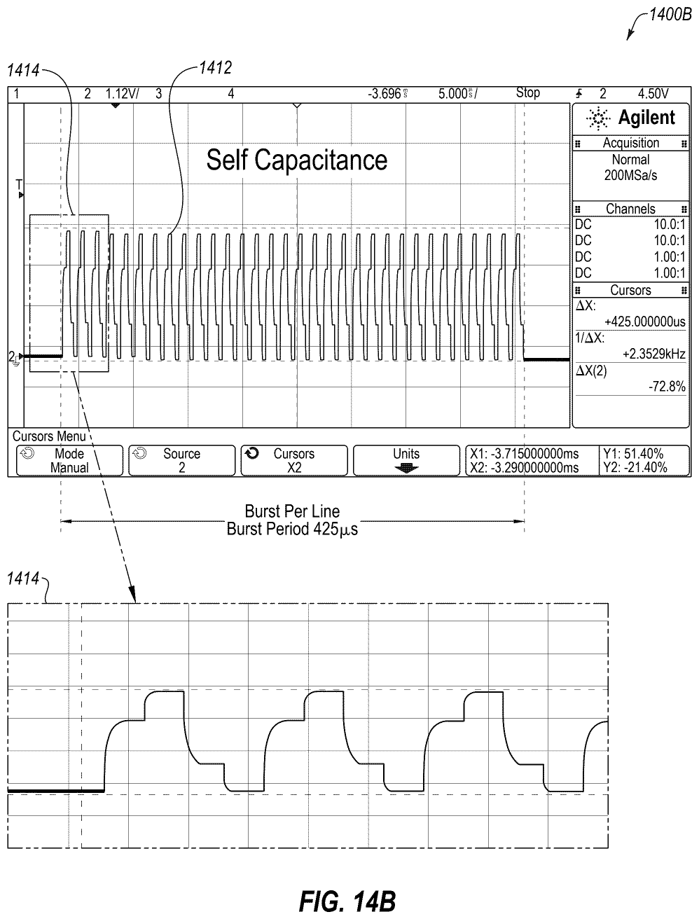

FIG. 13 is a schematic diagram of an acquisition front end circuit 1302 including a driver circuit 1310 and a sense circuit 1318 for describing touch detection at a sensor node associated with two sensor electrodes. In acquisition front end circuit 1302, a drive line pad 1312 (“X_Out”) is coupled to an output of driver circuit 1310, and a sense line pad 1316 (“Y_In”) is coupled to an input of sense circuit 1318. As indicated, driver circuit 1310 may have an adjustable slew rate and sense circuit 1318 may have an adjustable gain. A node capacitance Cx of a capacitor 1314 is present at a sensor node, where capacitor 1314 is indicated as coupled between drive line pad 1312 and sense line pad 1316. A drive signal 1304 in the form of a series of “X-pulse” bursts may be generated at the output of driver circuit 1310. Mutual capacitance may be measured between the two sensor electrodes, detected at an output of sense circuit 1318, where a sufficient change in capacitance between the two sensor electrodes indicates a touch event. In one or more examples, the touch detection shown and described in relation to FIG. 13 may be used as one example approach to the circuit arrangement and methodology described in relation to FIG. 14A or 14B. Other examples of drive signals are shown and described in relation to FIGS. 14A and 14B.

FIG. 14A is a graph 1400A of a drive signal 1402 for driving sensor electrodes for touch detection based on mutual capacitance measurements, according to one or more examples. In one or more examples, drive signal 1402 may be used in acquisition front end circuit 1302 of FIG. 13. A portion of drive signal 1402 is shown in an enlarged view in a view window 1404. Drive signal 1402 includes a series of bursts at a particular frequency, each burst having a burst period of 130 microseconds (μS).

FIG. 14B is a graph 1400B of a drive signal 1412 for driving sensor electrodes for touch detection based on self-capacitance measurements, according to one or more examples. A portion of drive signal 1412 is shown in an enlarged view in a view window 1414. Drive signal 1412 includes a series of bursts at a particular frequency, each burst having a burst period of 425 μS.

Graph 1400A of drive signal 1402 in FIG. 14A and graph 1400B of drive signal 1412 in FIG. 14B are provided as some examples of the types of drive signals that may be generated by an acquisition front end of a touch sensor (e.g., acquisition front end 302 of touch controller 410 of FIG. 4A or FIG. 4B), to better illustrate the adaptability of the existing circuitry of touch controller 410 to perform RFID read processing (e.g., signal processing including signal transmission processing and signal reception processing).

In one or more examples of the disclosure, capacitive touch systems including touch controllers have been described for use in computing devices. In one or more alternative examples, any suitable type of touch system may be used. For example, the touch controller may operate with a projected capacitive resistive touch system, a resistive touch system, a surface acoustic wave (SAW) touch system, an infrared (IR) resistive touch system, or an optical resistive touch system, without limitation.

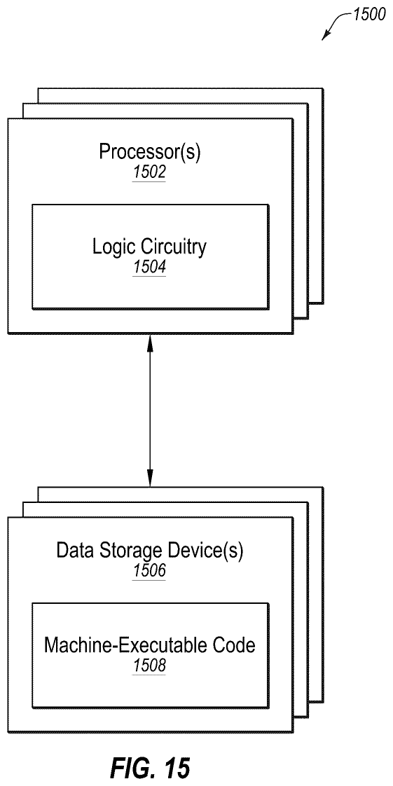

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 15 illustrates non-limiting examples of implementations of functional elements disclosed herein. In some examples, some or all portions of the functional elements disclosed herein may be performed by hardware specially implemented for carrying out the functional elements.

FIG. 15 is a block diagram of circuitry 1500 that, in some examples, may be used to implement various functions, operations, acts, processes, and/or methods disclosed herein. In one or more examples, circuitry 1500 may be part of a computing device of a computing system (e.g., a PoS device of a PoS system, an access control device of an access control system, and so on). Circuitry 1500 includes one or more processors 1502 (sometimes referred to herein as “processors 1502”) operably coupled to one or more data storage devices (sometimes referred to herein as “storage 1506”). Storage 1506 includes machine-executable code 1508 stored thereon and processors 1502 include a logic circuitry 1504. Machine-executable code 1508 includes information describing functional elements that may be implemented by (e.g., performed by) logic circuitry 1504. Logic circuitry 1504 is adapted to implement (e.g., perform) the functional elements described by machine-executable code 1508. Circuitry 1500, when executing the functional elements described by machine-executable code 1508, should be considered as special purpose hardware for carrying out functional elements disclosed herein. In some examples, processors 1502 may perform the functional elements described by machine-executable code 1508 sequentially, concurrently (e.g., on one or more different hardware platforms), or in one or more parallel process streams.

When implemented by logic circuitry 1504 of processors 1502, machine-executable code 1508 adapts processors 1502 to perform operations of examples disclosed herein. For example, machine-executable code 1508 may adapt processors 1502 to perform at least a portion or a totality of the methods or processes described herein. In one or more examples, machine-executable code 1508 may adapt processors 1502 to perform at least a portion or a totality of the methods or processes associated with the methodologies described in relation to FIGS. 4A, 4B, 9, 10, and/or 11.

Processors 1502 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to machine-executable code 1508 (e.g., software code, firmware code, hardware descriptions) related to examples of the present disclosure. It is noted that a general-purpose processor (may also be referred to herein as a host processor or simply a host) may be a microprocessor, but in the alternative, processors 1502 may include any conventional processor, controller, microcontroller, or state machine. Processors 1502 may also be implemented as a combination of computing devices, such as a combination of a DSP and a microprocessor, a plurality of microprocessors, one or more microprocessors in conjunction with a DSP core, or any other such configuration.

In some examples, storage 1506 includes volatile data storage (e.g., random-access memory (RAM)), non-volatile data storage (e.g., Flash memory, a hard disc drive, a solid state drive, erasable programmable read-only memory (EPROM), etc.). In some examples, processors 1502 and storage 1506 may be implemented into a single device (e.g., a semiconductor device product, a system on chip (SoC), etc.). In some examples, processors 1502 and storage 1506 may be implemented into separate devices.

In some examples, machine-executable code 1508 may include computer-readable instructions (e.g., software code, firmware code). By way of non-limiting example, the computer-readable instructions may be stored by storage 1506, accessed directly by processors 1502, and executed by processors 1502 using at least logic circuitry 1504. Also by way of non-limiting example, the computer-readable instructions may be stored on storage 1506, transferred to a memory device (not shown) for execution, and executed by processors 1502 using at least logic circuitry 1504. Accordingly, in some examples, logic circuitry 1504 includes electrically configurable logic circuitry 1504.

In some examples, machine-executable code 1508 may describe hardware (e.g., circuitry) to be implemented in logic circuitry 1504 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog, or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuitries (e.g., gates, flip-flops, registers, without limitation) of logic circuitry 1504 may be described in an RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, machine-executable code 1508 may include an HDL, an RTL, a GL description, a mask level description, other hardware description, or any combination thereof.

In examples where machine-executable code 1508 includes a hardware description (at any level of abstraction), a system (not shown, but including storage 1506) may implement the hardware description described by machine-executable code 1508. By way of non-limiting example, processors 1502 may include a programmable logic device (e.g., an FPGA or a PLC) and logic circuitry 1504 may be electrically controlled to implement circuitry corresponding to the hardware description into logic circuitry 1504. Also by way of non-limiting example, logic circuitry 1504 may include hard-wired logic manufactured by a manufacturing system (not shown, but including storage 1506) according to the hardware description of machine-executable code 1508.

Regardless of whether machine-executable code 1508 includes computer-readable instructions or a hardware description, logic circuitry 1504 is adapted to perform the functional elements described by machine-executable code 1508 when implementing the functional elements of machine-executable code 1508. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc.

Any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

A non-exhaustive, non-limiting list of examples follows. Not each of the examples listed below is explicitly and individually indicated as being combinable with all others of the examples listed below and examples discussed above. It is intended, however, that these examples are combinable with all other examples unless it would be apparent to one of ordinary skill in the art that the examples are not combinable.
Example 1: An apparatus comprising: a capacitive touch system including: a touch controller; a touch sensor operably coupled to the touch controller; a radio frequency (RF) identification (RFID) antenna operably coupled to the touch controller; the touch controller to: receive capacitance signals from the touch sensor; determine touch position data based, at least in part, on the capacitance signals; drive an RF signal to the RFID antenna for transmission of the RF signal from the RFID antenna, the RF signal to activate an RFID tag to produce a modulated RF signal modulated according to RFID data of the RFID tag; receive a demodulated signal indicating the RFID data, the demodulated signal demodulated from the modulated RF signal received from the RFID antenna; and detect the RFID data from the demodulated signal.
Example 2: The apparatus according to Example 1, comprising: a host controller to control one or more operations of the apparatus, the host controller coupled to the touch controller via a communication bus, the touch controller to communicate the touch position data to the host controller via the communication bus.
Example 3: The apparatus according to Examples 1 and 2, wherein: the touch controller is to: communicate the RFID data to the host controller via the communication bus.
Example 4: The apparatus according to any of Examples 1 to 3, wherein: the touch controller is to: encrypt the RFID data; and communicate the encrypted RFID data to the host controller via the communication bus.
Example 5: The apparatus according to any of Examples 1 to 4, wherein: the touch controller is to: determine whether the RFID data meets one or more predetermined criteria; provide a trigger pulse to the host controller responsive to the RFID data meeting the one or more predetermined criteria; and communicate the RFID data to the host controller via the communication bus responsive to providing the trigger pulse.
Example 6: The apparatus according to any of Examples 1 to 5, wherein the detected RFID data comprises a detected identification number: the touch controller is to: receive, from the host controller, a number of identification numbers and store the number of identification numbers in memory; compare the detected identification number and respective ones of the number of identification numbers stored in the memory; and communicate the detected identification number to the host controller at least partially responsive to a match between the detected identification number and one of the number of identification numbers stored in the memory.
Example 7: The apparatus according to any of Examples 1 to 6, wherein: the capacitive touch system includes: a demodulator external to the touch controller, the demodulator coupled to the RFID antenna and the touch controller, the demodulator to demodulate the modulated RF signal received from the RFID antenna.
Example 8: The apparatus according to any of Examples 1 to 7, wherein: the touch controller includes: a demodulator, the demodulator coupled to the RFID antenna, the demodulator to demodulate the modulated RF signal received from the RFID antenna.
Example 9: The apparatus according to any of Examples 1 to 8, wherein: the touch controller is to drive the RF signal to the RFID antenna at least partially responsive to detecting presence, at the touch sensor, of a transaction card that carries the RFID tag.
Example 10: The apparatus according to any of Examples 1 to 9, wherein: the touch controller is to: prior to driving the RF signal to the RFID antenna, pause one or more scanning operations used to receive the capacitance signals from the touch sensor.
Example 11: The apparatus according to any of Examples 1 to 10, wherein the RFID antenna comprises conductive material on one or more layers of the touch sensor.
Example 12: The apparatus according to any of Examples 1 to 11, wherein the apparatus comprises a point of sales (PoS) device including the capacitive touch system, and the RFID data comprises a unique identifier associated with a transaction card.
Example 13: The apparatus according to any of Examples 1 to 12, wherein: the touch controller includes: a digital signal processor (DSP) circuitry; a central processor operably coupled to the DSP circuitry; a number of transmit lines for coupling to the touch sensor; a drive circuitry, the drive circuitry coupled to the number of transmit lines, the drive circuitry to drive modulated signals to respective ones of the number of transmit lines; a number of receive lines for coupling to the touch sensor; a sense circuitry, the sense circuitry coupled to the number of receive lines, the sense circuitry to detect the capacitance signals of the touch sensor from respective ones of the number of receive lines; and an input/output (I/O) interface circuitry coupled to the central processor, the I/O interface circuitry for connection to a host controller for communication of the touch position data and the RFID data to the host controller.
Example 14: The apparatus according to any of Examples 1 to 13, wherein: the touch controller includes: an RFID antenna transmit line coupled to the RFID antenna; an RFID antenna driver circuit coupled to the RFID antenna transmit line, the DSP circuitry and the RFID antenna driver circuit to drive the RF signal to the RFID antenna for transmission of the RF signal from the RFID antenna; an RFID antenna receive line coupled to the RFID antenna; and an RFID antenna sense circuit coupled to the RFID antenna receive line, the RFID antenna sense circuit to detect the RFID data from the demodulated signal.
Example 15: A method comprising: at a touch controller, receiving capacitance signals from a touch sensor; determining touch position data based, at least in part, on the capacitance signals; generating a radio frequency (RF) signal for transmission from an RFID antenna, the RF signal to activate an RFID tag to produce a modulated RF signal modulated according to RFID data of the RFID tag; receiving a demodulated signal indicating the RFID data, the demodulated signal demodulated from the modulated RF signal received from the RFID antenna; and detecting the RFID data from the demodulated signal.
Example 16: The method according to Example 15, comprising: at the touch controller, communicating the touch position data to a host controller.
Example 17: The method according to Examples 15 and 16, comprising: at the touch controller, communicating the RFID data to the host controller.
Example 18: The method according to any of Examples 15 to 17, comprising: at the touch controller, receiving the demodulated signal from a demodulator external to the touch controller.
Example 19: The method according to any of Examples 15 to 18, comprising: at the touch controller, receiving the modulated RF signal from the RFID antenna; and demodulating, in a demodulator within the touch controller, the modulated RF signal to generate the demodulated signal.
Example 20: The method according to any of Examples 15 to 19, comprising: at the touch controller, detecting presence, at the touch sensor, of a transaction card that carries the RFID tag, wherein generating the RF signal for transmission from the RFID antenna is at least partially responsive to the detected presence of the card that carries the RFID tag.
Example 21: The method according to any of Examples 15 to 20, comprising: at the touch controller, prior to generating the RF signal for transmission from the RFID antenna in an RFID scan, pausing one or more scanning operations used to receive the capacitance signals from the touch sensor; and after completion of the RFID scan, resuming the one or more scanning operations used to receive the capacitance signals from the touch sensor.
Example 22: A touch controller, comprising: a digital signal processor (DSP) circuitry; a central processor operably coupled to the DSP circuitry; a number of transmit lines for coupling to a touch sensor; a number of receive lines for coupling to the touch sensor; a drive circuitry coupled to the number of transmit lines, the DSP circuitry and the drive circuitry to drive modulated signals to respective ones of the number of transmit lines; a sense circuitry coupled to the number of receive lines, the sense circuitry to sense capacitance signals of the touch sensor from respective ones of the number of receive lines; a radio frequency (RF) identification (RFID) antenna transmit line for coupling to an RFID antenna; and an RFID antenna driver circuit coupled to the RFID antenna transmit line, the DSP circuitry and the RFID antenna driver circuit to generate an RF signal for transmission from the RFID antenna.
Example 23: The touch controller according to Example 22, wherein the RF signal is to activate an RFID tag to produce a modulated RF signal modulated according to RFID data of the RFID tag, the touch controller comprising: an RFID antenna receive line for coupling to the RFID antenna; and an RFID antenna sense circuit coupled to the RFID antenna receive line, the RFID antenna sense circuit to detect the RFID data from a demodulated signal, the demodulated signal demodulated from the modulated RF signal received from the RFID antenna.
Example 24: The touch controller according to Examples 22 and 23, wherein the RFID antenna sense circuit is for coupling to a demodulator external to the touch controller, the demodulator to demodulate the modulated RF signal received from the RFID antenna.
Example 25: The touch controller according to any of Examples 22 to 24, comprising: a demodulator, the demodulator coupled to the RFID antenna sense circuit via the RFID antenna receive line, the demodulator to demodulate the modulated RF signal received from the RFID antenna.
Example 26: The touch controller according to any of Examples 22 to 25, comprising: the DSP circuitry to determine touch position data based, at least in part, on the capacitance signals; and an input/output (I/O) interface circuitry, the I/O interface circuitry coupled to the central processor, the I/O interface circuitry for connection to a host controller for communication of the touch position data and the RFID data to the host controller.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus comprising:
a capacitive touch system including:
a touch controller;
a touch sensor operably coupled to the touch controller;
a radio frequency (RF) identification (RFID) antenna operably coupled to the touch controller;
the touch controller to:
receive capacitance signals from the touch sensor;
determine touch position data based, at least in part, on the capacitance signals;
drive an RF signal to the RFID antenna for transmission of the RF signal from the RFID antenna, the RF signal to activate an RFID tag to produce a modulated RF signal modulated according to RFID data of the RFID tag;
receive a demodulated signal indicating the RFID data, the demodulated signal demodulated from the modulated RF signal received from the RFID antenna; and
detect the RFID data from the demodulated signal.

2. The apparatus of claim 1, comprising:
a host controller to control one or more operations of the apparatus, the host controller coupled to the touch controller via a communication bus, the touch controller to communicate the touch position data to the host controller via the communication bus.

3. The apparatus of claim 2, wherein:
the touch controller is to:
communicate the RFID data to the host controller via the communication bus.

4. The apparatus of claim 2, wherein:
the touch controller is to:
encrypt the RFID data; and
communicate the encrypted RFID data to the host controller via the communication bus.

5. The apparatus of claim 2, wherein:
the touch controller is to:
determine whether the RFID data meets one or more predetermined criteria;
provide a trigger pulse to the host controller responsive to the RFID data meeting the one or more predetermined criteria; and
communicate the RFID data to the host controller via the communication bus responsive to providing the trigger pulse.

6. The apparatus of claim 2, wherein the detected RFID data comprises a detected identification number, and wherein:
the touch controller is to:
receive, from the host controller, a number of identification numbers and store the number of identification numbers in memory;
compare the detected identification number and respective ones of the number of identification numbers stored in the memory; and
communicate the detected identification number to the host controller at least partially responsive to a match between the detected identification number and one of the number of identification numbers stored in the memory.

7. The apparatus of claim 1, wherein:
the capacitive touch system includes:
a demodulator external to the touch controller, the demodulator coupled to the RFID antenna and the touch controller, the demodulator to demodulate the modulated RF signal received from the RFID antenna.

8. The apparatus of claim 1, wherein:
the touch controller includes:
a demodulator, the demodulator coupled to the RFID antenna, the demodulator to demodulate the modulated RF signal received from the RFID antenna.

9. The apparatus of claim 1, wherein:
the touch controller is to drive the RF signal to the RFID antenna at least partially responsive to detecting presence, at the touch sensor, of a transaction card that carries the RFID tag.

10. The apparatus of claim 1, wherein:
the touch controller is to:
prior to driving the RF signal to the RFID antenna, pause one or more scanning operations used to receive the capacitance signals from the touch sensor.

11. The apparatus of claim 1, wherein the RFID antenna comprises conductive material on one or more layers of the touch sensor.

12. The apparatus of claim 1, wherein the apparatus comprises a point of sales (POS) device including the capacitive touch system, and the RFID data comprises a unique identifier associated with a transaction card.

13. The apparatus of claim 1, wherein:
the touch controller includes:
a digital signal processor (DSP) circuitry;
a central processor operably coupled to the DSP circuitry;
a number of transmit lines for coupling to the touch sensor;
a drive circuitry, the drive circuitry coupled to the number of transmit lines, the drive circuitry to drive modulated signals to respective ones of the number of transmit lines;
a number of receive lines for coupling to the touch sensor;
a sense circuitry, the sense circuitry coupled to the number of receive lines, the sense circuitry to detect the capacitance signals of the touch sensor from respective ones of the number of receive lines; and
an input/output (I/O) interface circuitry coupled to the central processor, the I/O interface circuitry for connection to a host controller for communication of the touch position data and the RFID data to the host controller.

14. The apparatus of claim 13, wherein:
the touch controller includes:
an RFID antenna transmit line coupled to the RFID antenna;
an RFID antenna driver circuit coupled to the RFID antenna transmit line, the DSP circuitry and the RFID antenna driver circuit to drive the RF signal to the RFID antenna for transmission of the RF signal from the RFID antenna;
an RFID antenna receive line coupled to the RFID antenna; and
an RFID antenna sense circuit coupled to the RFID antenna receive line, the RFID antenna sense circuit to detect the RFID data from the demodulated signal.

15. A method comprising:
at a touch controller,
receiving capacitance signals from a touch sensor;
determining touch position data based, at least in part, on the capacitance signals;
generating a radio frequency (RF) signal for transmission from an RFID antenna, the RF signal to activate an RFID tag to produce a modulated RF signal modulated according to RFID data of the RFID tag;
receiving a demodulated signal indicating the RFID data, the demodulated signal demodulated from the modulated RF signal received from the RFID antenna; and
detecting the RFID data from the demodulated signal.

16. The method of claim 15, comprising:
at the touch controller,
communicating the touch position data to a host controller.

17. The method of claim 16, comprising:
at the touch controller,
communicating the RFID data to the host controller.

18. The method of claim 15, comprising:
at the touch controller,
receiving the demodulated signal from a demodulator external to the touch controller.

19. The method of claim 15, comprising:
at the touch controller,
receiving the modulated RF signal from the RFID antenna; and
demodulating, in a demodulator within the touch controller, the modulated RF signal to generate the demodulated signal.

20. The method of claim 15, comprising:
at the touch controller,
detecting presence, at the touch sensor, of a transaction card that carries the RFID tag,
wherein generating the RF signal for transmission from the RFID antenna is at least partially responsive to the detected presence of the card that carries the RFID tag.

21. The method of claim 15, comprising:
at the touch controller,
prior to generating the RF signal for transmission from the RFID antenna in an RFID scan, pausing one or more scanning operations used to receive the capacitance signals from the touch sensor; and
after completion of the RFID scan, resuming the one or more scanning operations used to receive the capacitance signals from the touch sensor.

22. A touch controller, comprising:
a digital signal processor (DSP) circuitry;
a central processor coupled to the DSP circuitry;
a number of transmit lines for coupling to a touch sensor;
a number of receive lines for coupling to the touch sensor;
a drive circuitry coupled to the number of transmit lines, the DSP circuitry and the drive circuitry to drive modulated signals to respective ones of the number of transmit lines;
a sense circuitry coupled to the number of receive lines, the sense circuitry to sense capacitance signals of the touch sensor from respective ones of the number of receive lines;
a radio frequency (RF) identification (RFID) antenna transmit line for coupling to an RFID antenna; and
an RFID antenna driver circuit coupled to the RFID antenna transmit line, the DSP circuitry and the RFID antenna driver circuit to generate an RF signal for transmission from the RFID antenna.

23. The touch controller of claim 22, wherein the RF signal is to activate an RFID tag to produce a modulated RF signal modulated according to RFID data of the RFID tag, the touch controller comprising:
an RFID antenna receive line for coupling to the RFID antenna; and
an RFID antenna sense circuit coupled to the RFID antenna receive line, the RFID antenna sense circuit to detect the RFID data from a demodulated signal, the demodulated signal demodulated from the modulated RF signal received from the RFID antenna.

24. The touch controller of claim 23, wherein the RFID antenna sense circuit is for coupling to a demodulator external to the touch controller, the demodulator to demodulate the modulated RF signal received from the RFID antenna.

25. The touch controller of claim 23, comprising:
a demodulator, the demodulator coupled to the RFID antenna sense circuit via the RFID antenna receive line, the demodulator to demodulate the modulated RF signal received from the RFID antenna.

26. The touch controller of claim 23, comprising:
the DSP circuitry to determine touch position data based, at least in part, on the capacitance signals; and
an input/output (I/O) interface circuitry, the I/O interface circuitry coupled to the central processor, the I/O interface circuitry for connection to a host controller for communication of the touch position data and the RFID data to the host controller.
